(19) United States
(12) Patent Application Publication
(10) Pub. No.: US 2007/0167123 A1
(43) Pub. Date: Jul. 19, 2007

(54) Meat Packaging System

(76) Inventors: John W. Countz, Grand Cayman (KY); Rudy Steiner, Dodge City, KS (US)

Correspondence Address: Christopher M. Turoski, Esq.;Cargill, Incorporated, 14507 McGinty Road West, Wayzata, MN, 55391-5624, US

(21) Appl. No.: 11/617,469

(22) Filed: Dec. 28, 2006

Related U.S. Application Data
(63) Continuation of application No. PCT/US05/23065, filed on Jun. 28, 2005.
(60) Provisional application No. 60/583,974, filed on Jun. 28, 2004.
(60) Provisional application No. 60/591,425, filed on Jul. 27, 2004.

(51) Int. Cl. A22C 17/16

(52) U.S. Cl. 452/134

(57) ABSTRACT

A system and method for rapidly binding fresh meat myoglobin with carbon monoxide. The method includes placing the fresh meat into a chamber, creating a negative pressure within the chamber, pressurizing the chamber with an atmosphere including carbon monoxide, maintaining the chamber at hyperbaric levels of pressure for a dwell time and bringing the chamber to regular atmospheric pressure. The myoglobin of the meat within the chamber is thereby rapidly converted to carboxymyoglobin and, thus, the meat appears normally oxygenated. The meat may be placed into a low oxygen atmosphere or vacuum packaging machine and packaged accordingly.

### CROSS-REFERENCE TO RELATED APPLICATION

This application is a continuation of International Patent Application No. PCT/US2005/023065, filed on Jun. 28, 2005, which claims the benefit of U.S. Provisional Application No. 60/591,425, filed Jul. 27, 2004, and the benefit of priority of U.S. Provisional Application No. 60/583,974, filed on Jun. 28, 2004, the contents of both of which are incorporated herein by reference.

### FIELD OF THE INVENTION

The packaging system relates to a fresh meat packaging system and a process for producing a generally red coloration, for example, a bright cherry-red, upon the meat, for example upon the surface of the meat. More specifically, the packaging system relates to rapid binding of gas to fresh meat myoglobin. The packaging system relates to a process by which fresh meat myoglobin (MbFe(II)) is infused with carbon monoxide to produce a generally red coloration, carboxymyoglobin (MbFe(II)CO) upon the surface of the meat, thus simulating normal atmospheric oxygenation of meat within a vacuum-sealed or low oxygen atmosphere package.

### BACKGROUND

The color of fresh meat is important to the marketing of meat, and numerous studies have been carried out to identify the factors controlling the color stability of meat. It is generally accepted that, to preserve the natural fresh color of meat, steps must be taken to prevent auto-oxygenation of the meat. In the case of red meat, controlled exposure of the meat product to oxygen is necessary to oxygenate the meat pigment myoglobin, MbFe(II) to the bright red of oxymyglobin, MbFe(II)O₂. This controlled oxygen exposure results in a desired “bloom” of the meat to a bright red color, which the typical retail customer associates with freshness. However, prolonged exposure to oxygen causes the conversion of myoglobin meat pigmentation to metmyoglobin. Metmyoglobin has a gray or brown color that is generally considered undesirable to the typical retail customer. Furthermore, prolonged exposure of fresh meat to oxygen also often causes accelerated bacterial decay of the meat product.

Fresh meat products are typically processed from primals to various cuts in a meat processing facility, and then packaged in controlled atmospheric conditions for shipment directly to a retailer, such as a grocery store or supermarket. To prevent discoloration and extend the shelf life of meat products, modified atmosphere packaging (“MAP”) techniques are conventionally used. In the absence of a modified atmosphere, oxymyoglobin is eventually converted to metmyoglobin, which has an unappealing brown color. This conversion occurs before microbial spoilage renders the product unfit for human consumption. Modified atmosphere packaging attempts to address some of the causes of auto-oxygenation of myoglobin, in particular, the effects of the partial pressure of oxygen on the color stability of oxymyoglobin.

Modified atmosphere technology is widely employed throughout the food industry. A modified atmosphere may be achieved in two ways: by removing air from the package (i.e., vacuum packaging), or by replacing, after removal of ambient air, the normal package atmosphere with a specially formulated mixture of gases. Depending upon the desired function of the MAP, the gaseous mixture may contain differing levels of O₂, CO, CO₂, and/or N₂. The benefits of MAP systems are not available to the same extent under “normal” atmospheric conditions (i.e., 21% O₂, 78% N₂, and 0.1% CO₂).

MAP systems vary considerably depending upon the intended purpose. For instance, high levels of CO₂ have been demonstrated to inhibit microbial growth. High O₂ systems, containing 80% O₂, are widely used to prevent color degradation in beef and pork, maintaining the product's characteristic “cherry red” color. Modified atmosphere packaging usually comprises an atmosphere containing carbon dioxide (CO₂), oxygen (O₂), and nitrogen (N₂). The most common gas mixture for retail-ready meat contains approximately 80% O₂ and 20% CO₂, and gives the product an extended shelf-life compared to air. The shelf-life and color stability of meat stored in this gas mixture is somewhat limited.

Like oxygen, carbon monoxide (CO) has a color-stabilizing effect on fresh meat. When carbon monoxide comes into direct contact with meat, myoglobin, MbFe(II), is converted into carboxymyoglobin, MbFe(II)CO, resulting in a color that is substantially indistinguishable from that of oxymyoglobin, MbFe(II)O₂. Thus, to obtain a stable red color for the meat, low concentrations (<1%) of carbon monoxide have conventionally been introduced into MAP packaging. Oxygen is replaced with higher amounts of carbon dioxide in order to create anaerobic conditions, which may extend the shelf-life of meat products significantly when compared to air and oxygen-enriched atmospheres.

The conventional carbon monoxide infusion process comprises placing the meat product on a tray over-wrapped with porous webbing inside a sealed pillow bag filled with 0.4% CO by volume and allowing the meat myoglobin to absorb the carbon monoxide over a period of hours or days, typically approximately 24 to 48 hours. However, such processes take considerable time in the absorption of the carbon monoxide and do not enable control of the level of carbon monoxide infusion.

Other attempts have been made at developing packaging to maximize the shelf-life and color stability of meat. Short of freezing, vacuum packaging followed by refrigerated storage is the most effective method for shelf-life and color stability extension of fresh meat products. Vacuum packages are compact and durable during distribution. Vacuum packaging typically involves packaging the meat prior to oxygenation of the myoglobin. Consumer acceptance of vacuum package retail meat products has been low because of the dark reddish-purple color of the meat, resulting from the lack of oxymyoglobin due to the absence of oxygen in the package. Controlled exposure of the meat product to oxygen is necessary to oxygenate the myoglobin to the bright red of oxymyglobin associated with freshness. This controlled oxygen exposure does not usually occur with vacuum packaging.

### SUMMARY OF THE INVENTION

The packaging system relates to a fresh meat packaging system and a gas infusion process for producing a generally red coloration, such as a bright cherry-red coloration, upon the meat, for example upon the surface of the meat. More specifically, the packaging system relates to a process by which fresh meat myoglobin (MbFe(II)) is infused with carbon monoxide to produce a generally red coloration carboxymyoglobin (MbFe(II)CO) upon the surface of the meat, thus simulating normal atmospheric oxygenation within a vacuum-sealed or low oxygen atmosphere package.

The meat packaging system presents consumers with a fresh meat product that may be vacuum packaged while having a generally red coloration. Consumers generally equate freshness with the normally oxygenated color of meat. While vacuum or low-oxygen atmospherically packaged fresh meats have freezer ready and extended shelf life attributes, they typically do not have a generally red color and are, therefore, unattractive to consumers. The packaging allows for the freezer ready and extended shelf life attributes of vacuum and low oxygen packaging while maintaining product color attractiveness to the average retail consumer.

The packaging system provides a process by which carbon monoxide under hyperbaric atmosphere may be rapidly bound to the myoglobin on the surface layers of the meat according to one embodiment. The hyperbaric carbon monoxide atmosphere rapidly creates a generally red color on the surface of the meat. The packaging system provides a rapid method, for example in approximately two minutes, of accelerating CO uptake in the surface layer of myoglobin of fresh meat products according to one embodiment. The meat may then be vacuum packaged or packaged in low oxygen packaging and presented directly to the consumer as an attractive product with superior color and shelf life characteristics.

The packaging system combines the benefits of a low oxygen or vacuum packaging with the color benefits of a high oxygen MAP program. The system of the packaging system confers the advantages of fresh meat color, less flavor degradation and less product deterioration due to the absence of elevated levels of CO₂ with maintenance of a bright red color that is familiar to consumers (i.e., benefits of a high oxygen MAP program).

A system of the packaging system includes a vacuum/pressure chamber for infusing a fresh meat product with carbon monoxide. The fresh meat is portioned and placed on a shelf within the vacuum/pressure chamber and the vacuum/pressure chamber is sealed. A vacuum source is applied to the inside of the vacuum/pressure chamber to remove most of the atmosphere inside the vacuum/pressure chamber and places the fresh meat in a state of negative atmospheric pressure or vacuum. After a specified dwell time under dynamic vacuum, the vacuum is replaced with a positive flow of CO from a CO source. After a specified dwell time the infusion is complete and a negative atmosphere is again applied to the vacuum/pressure vessel. Fresh air may be allowed to enter the chamber to cause residual carbon monoxide gas inside the chamber to be swept out

Thus, the packaging system provides a method of infusing fresh meat with carbon monoxide. In accordance with one embodiment of the packaging system, the method includes placing the fresh meat into a vacuum chamber, creating a negative pressure within the vacuum chamber, and pressurizing the chamber using carbon monoxide or a gas mixture including carbon monoxide, and removing the pressurized carbon monoxide gas from the chamber. The myoglobin of the meat within the pressure/vacuum chamber is converted to carboxymyoglobin and, thus, the meat appears normally oxygenated. The meat may be placed into a low oxygen atmosphere or vacuum packaging machine and packaged accordingly.

The use of carbon monoxide in the system of the packaging system does not preclude the browning of meat following removal from the modified environment by consumers. In other words, the system does not mask spoilage.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIG. 1 is a block diagram illustrating a carbon monoxide infusion process in accordance with one embodiment of the present invention.

FIG. 2 is a flowchart showing a fresh meat packaging method in accordance with a further embodiment of the present invention.

FIG. 3 is a schematic diagram illustrating a vacuum/pressure chamber, according to another embodiment of the present invention.

FIG. 4 is a flowchart showing a fresh meat packaging method in accordance with one embodiment of the present invention.

FIG. 5 is a schematic diagram illustrating a continuous, vacuum-packing system, according to another embodiment of the present invention.

FIG. 6 is a table illustrating the interaction effect of dwell time and pressure on color values of meat treated according to one embodiment of the present invention.

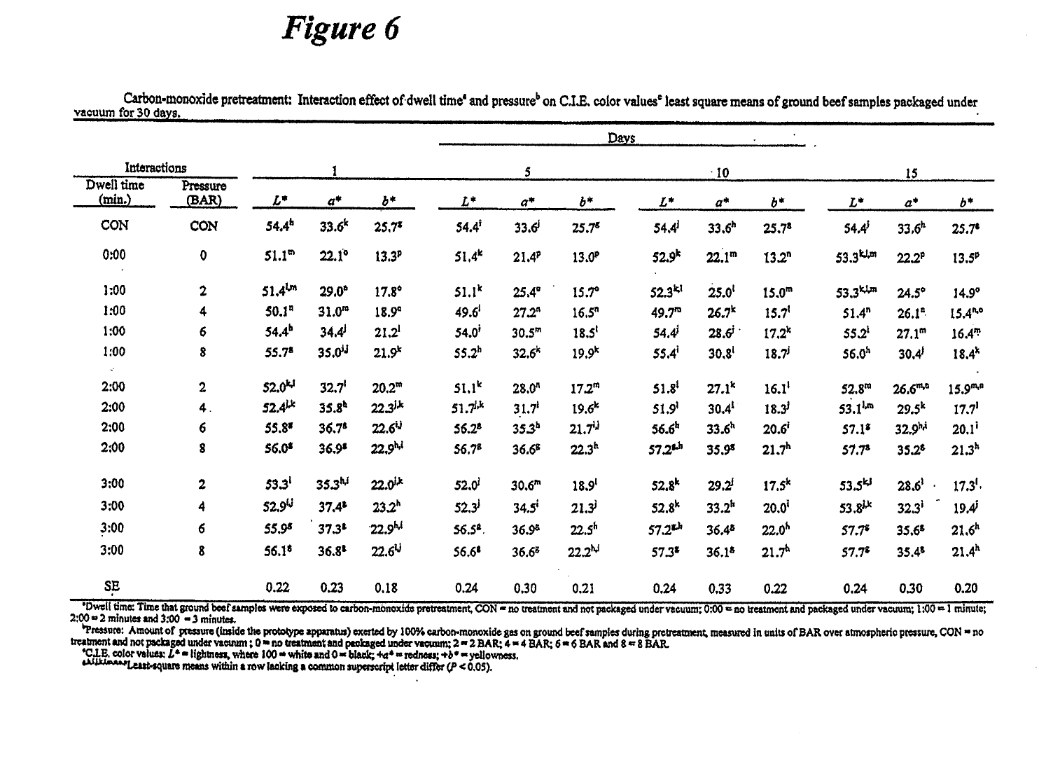

FIG. 7 is a table illustrating the interaction effect of dwell time and pressure on color values of meat treated according to one embodiment of the present invention.

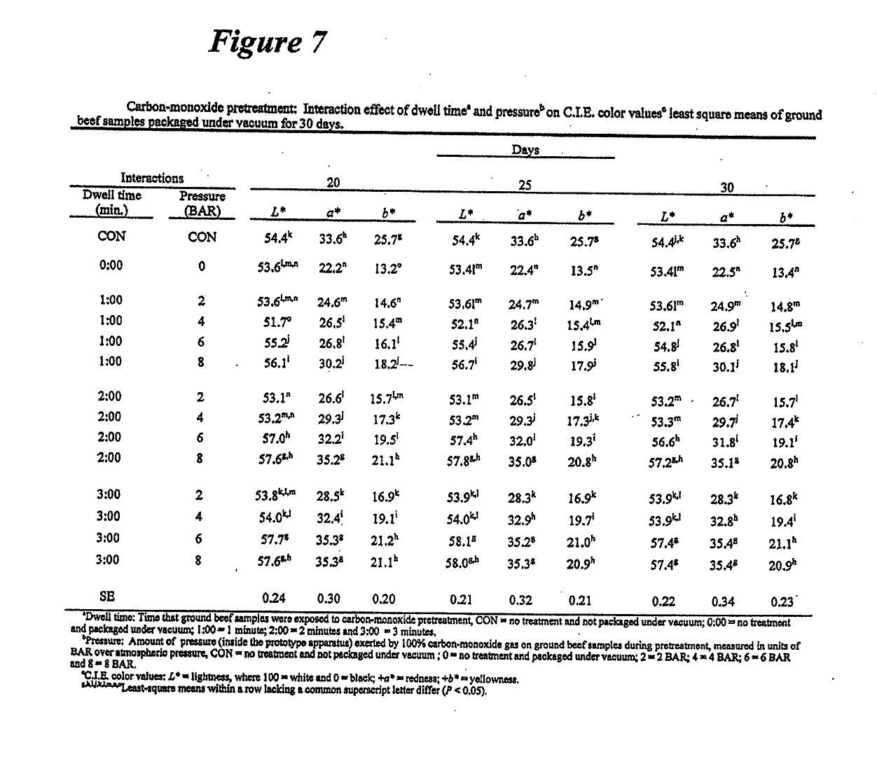

FIG. 8 is a table illustrating the interaction effect of dwell time and pressure on a* (redness)/b* (yellowness) ratio, hue angle and saturation of meat treated according to one embodiment of the present invention.

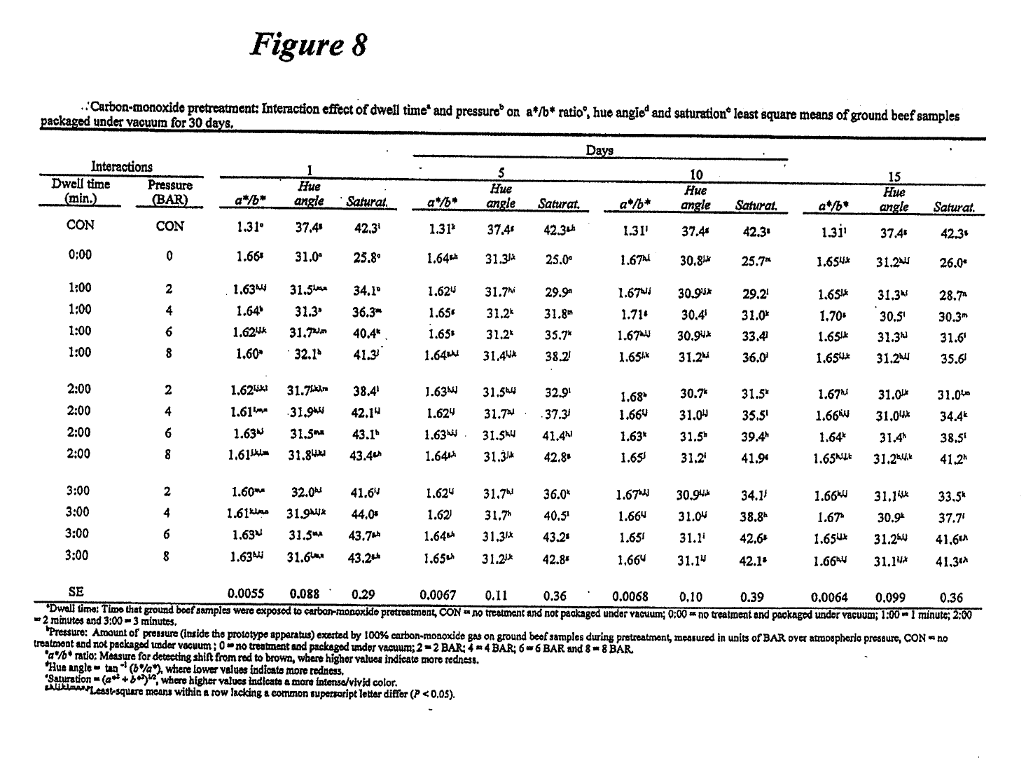

FIG. 9 is a table illustrating the interaction effect of dwell time and pressure on a* (redness)/b* (yellowness) ratio, hue angle and saturation of meat treated according to one embodiment of the present invention.

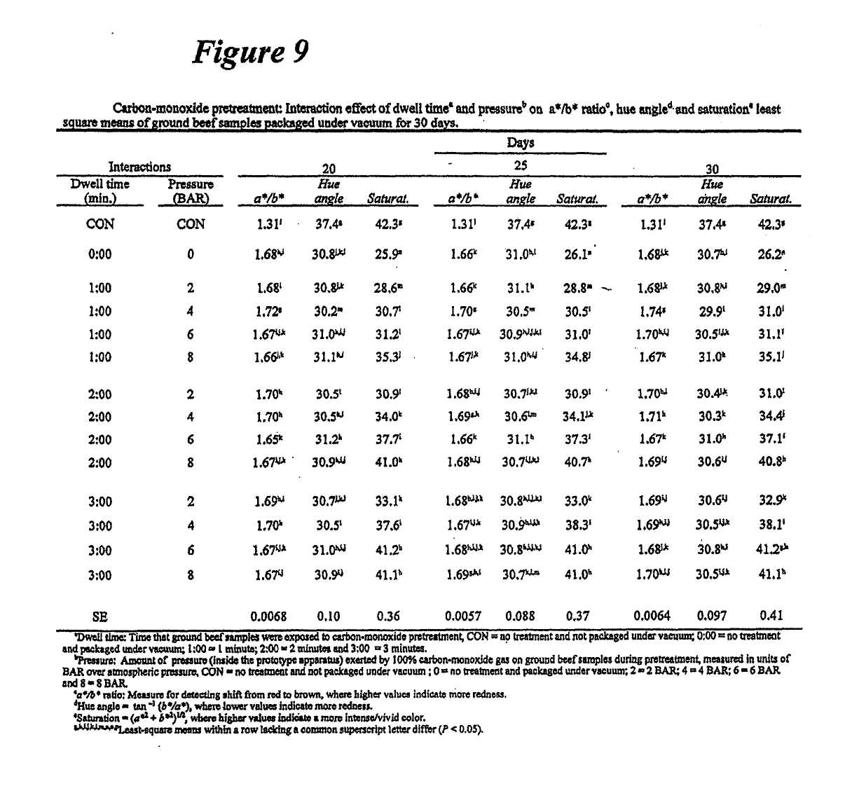

FIG. 10 is a graph illustrating a* (redness) versus b* (yellowness) at one minute dwell time over a period of 30 days, for meat treated in accordance with one embodiment of the present invention.

FIG. 11 is a graph illustrating a* (redness) versus b* (yellowness) at two minutes dwell time over a period of 30 days, for meat treated in accordance with one embodiment of the present invention.

FIG. 12 is a graph illustrating a* (redness) versus b* (yellowness) at three minutes dwell time over a period of 30 days, for meat treated in accordance with one embodiment of the present invention.

FIG. 13 is a graph illustrating L* (lightness) of meat treated in accordance with one embodiment of the present invention.

FIG. 14 is a graph illustrating a* (redness) of meat treated in accordance with one embodiment of the present invention.

FIG. 15 is a graph illustrating b* (yellowness) of meat treated in accordance with one embodiment of the present invention.

FIG. 16 is a graph illustrating hue angle of meat treated in accordance with one embodiment of the present invention.

FIG. 17 is a graph illustrating saturation of meat treated in accordance with one embodiment of the present invention.

### DETAILED DESCRIPTION

The packaging system provides a fresh meat packaging system and a carbon monoxide infusion process for producing a generally red coloration upon the meat. More specifically, the packaging system relates to a process by which fresh meat myoglobin (MbFe(II)) is exposed to a hyperbaric carbon monoxide atmosphere to rapidly produce a generally red coloration carboxymyoglobin (MbFe(II)CO) upon the surface of the meat, thus simulating normal atmospheric oxygenation within a vacuum-sealed or low oxygen atmosphere package.

Metmyoglobin, formed by the auto-oxygenation of the myoglobin and oxymyoglobin, causes brown discoloration of meat. The relative rates of auto-oxygenation of myoglobin and oxymyoglobin affect the rate of metmyoglobin accumulation. The rate of auto-oxygenation of myoglobin and oxymyoglobin is influenced by several factors, including the oxygen partial pressure, exposure to light, product pH, salt concentration, temperature, presence or absence of certain lipid oxygenation products, and exposure to high hydrostatic pressure.

Unlike oxygen, carbon monoxide (CO) has a prolonged color-stabilizing effect on fresh meat. The desirable red color of fresh beef, in particular, is attributed to oxymyoglobin, formed when the myoglobin pigment in meat is exposed to oxygen. Carbon monoxide has an affinity to myoglobin that is approximately 300 times greater than that of oxygen. When carbon monoxide comes into direct contact with meat, myoglobin, MbFe(II), is converted into carboxymyoglobin, MbFe(II)CO, resulting in a color that is substantially indistinguishable from that of oxymyoglobin, MbFe(II)O₂. Carboxymyoglobin is extremely color stable and has an absorption spectra nearly identical to oxymyoglobin. Carbon monoxide does not affect the ability of a MAP system to slow the growth of microorganisms, nor does it affect the characteristic odor of meat spoilage.

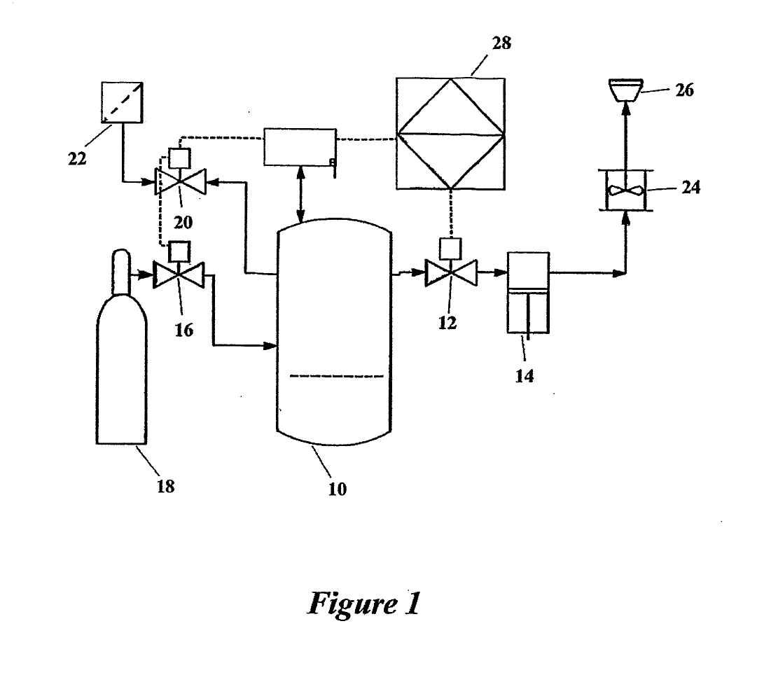

FIG. 1 illustrates an embodiment of the packaging system. The fresh meat is portioned and placed on a shelf within the vacuum/pressure chamber 10 and the vacuum/pressure chamber 10 is sealed. The vacuum valve 12 is actuated to the open flow or vacuum position and the vacuum source 14 is applied to the inside of the vacuum/pressure chamber 10, at approximately 20-29.5 in Hg, which removes most of the atmosphere inside the vacuum/pressure chamber 10 and places the fresh meat in a state of negative atmospheric pressure or vacuum. After a specified dwell time under dynamic vacuum (e.g., approximately 15 seconds) the vacuum valve 12 is actuated to the closed position and the CO pressure valve 16 is actuated to the open flow position, replacing the vacuum inside the vacuum/pressure chamber 10 with a positive flow of CO from the CO source 18 which is regulated to a positive pressure, of between approximately 0.1 and 34.5 bar, in some embodiments between approximately 10 and 34.5 bar. Upon reaching a preset pressure, the CO pressure valve 16 is returned to the closed position. The meat inside the vacuum/pressure has now been taken from a hypobaric to a hyperbaric state, from vacuum to positive pressure carbon monoxide. The resulting hyperbaric atmosphere accelerates the uptake of carbon monoxide by the meat's myoglobin by significantly increasing the molar density of the carbon monoxide gas over the surface area of the meat product, which in turn causes the meat to appear normally oxygenated. After a specified dwell time (for example, approximately 5 minutes at 1 bar or approximately 90 seconds at 8 bar) the vacuum valve 12 is actuated back to the vacuum position and a negative atmosphere is again applied to the vacuum/pressure vessel 10. The fresh air supply valve 20 is then actuated to the open position allowing fresh air to enter through filter 22, causing residual carbon monoxide gas inside the chamber to be swept out through the vacuum source 14 and vented outside the building through the exhaust fan 24 and exhaust header 26 for safety. All valve actuations and dwell timings are performed by the system controller 28.

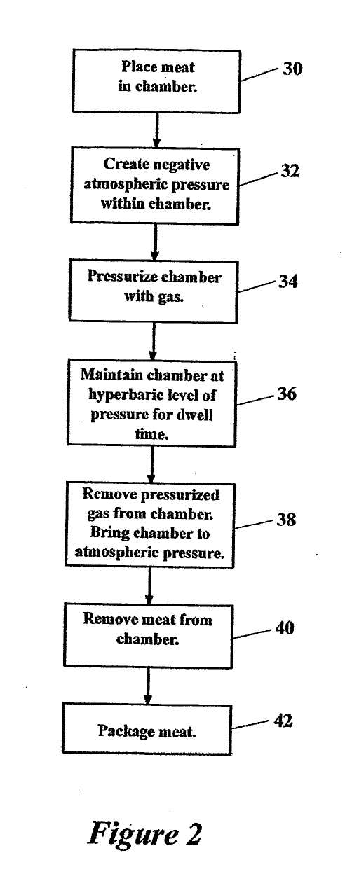

FIG. 2 depicts a detailed method of carbon monoxide infusion in accordance with an embodiment the packaging system. At block 30, the pressure/vacuum chamber is opened, the meat is placed in the chamber and the chamber is sealed. The atmosphere is evacuated from the pressure/vacuum chamber at block 32, thereby creating a negative atmospheric pressure within the pressure/vacuum chamber. At block 34, the pressure/vacuum chamber is enriched with carbon monoxide gas to a pressure of up to approximately 34.5 bar. The meat, at block 36, absorbs the gas up to a designated point of saturation. Within the pressure/vacuum chamber, the gas is pressurized and significantly dense, thus encouraging accelerated carbon monoxide uptake at the surface layer myoglobin of the fresh meat product. The saturation point may be estimated by measuring the dwell time of the meat in the pressure/vacuum chamber. The dwell time may be, for example, between 1 and 15 seconds. At or near the designated point of saturation, the pressurized carbon monoxide gas is removed from the pressure/vacuum chamber, shown at block 38. Fresh air is allowed to flush through at normal atmospheric pressure. At block 40, the pressure chamber is opened and the meat is removed. The myoglobin of the meat within the pressure/vacuum chamber is converted to carboxymyoglobin and, thus, the meat appears normally oxygenated. The meat may be placed into a low oxygen atmosphere or vacuum packaging machine and packaged accordingly, shown at block 42.

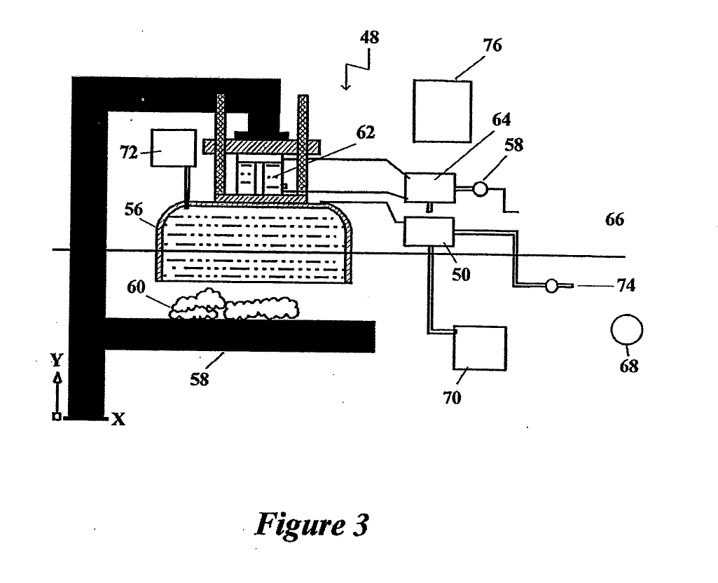

FIG. 3 is a schematic view illustrating a vacuum/pressure chamber assembly, according to an embodiment of the packaging system. As shown in FIG. 3, the vacuum/pressure chamber assembly 48 comprises an access door, vacuum control valve 50, a CO pressure valve, a vacuum source 52, an exhaust fan and an exhaust header. Optionally, a fresh air supply valve may be provided. The chamber 48 further includes a pressure vessel 56, a shelf 58, and an air cylinder 62. The pressure vessel 56 is rated from vacuum (29 in Hg) up to multiple atmospheres (34.5 bar). During operation, a fresh meat product 60 is placed on the shelf 58. The pressure vessel 56 is lowered by the air cylinder 62 until a seal, located along a lower edge of the pressure vessel 56, contacts the shelf 58 with sufficient force to pull a vacuum up to 29 in Hg and to pressurize to as high as 2 bar.

The air cylinder 62 is controlled using an air cylinder valve 64 connected to a compressed air source 66. Depending on the setting of the air cylinder valve 64, the air cylinder 62 either raises or lowers with respect to the shelf 58. The pressure inside the pressure vessel 56 is controlled using the pressure valve 50, which is coupled to a pressurized carbon monoxide source 68 and to a vacuum source 70. The pressure vessel 56 may include a bleed-off valve or exhaust 72 for venting the contents of the pressure vessel 56.

The carbon monoxide source 68 may include a tank of compressed carbon monoxide fitted with a regulator 74 to control the output gas pressure to the desired operational levels (generally between 0.1 and 2.0 bar). The source 68 may include carbon monoxide along with an inert gas, such as nitrogen or other gases commonly used in the packaging of meat products (for example, carbon dioxide, argon, etc.). The concentration of carbon monoxide gas may vary. For example, the concentration of carbon monoxide may range from 0.1% up to 100%. Higher carbon monoxide atmospheric pressure enables more rapid infusion dwell times, in addition, higher concentrations allow for lower pressure requirements.

The chamber 48 further may include a controller 76, including electronic components capable of controlling each of the various components of the chamber 76 and to receive status feedback from position indicators or limit switches. The system process controller 76 is preferably capable of executing timed switching functions to affect the proper operation of air and gas valves. The controller 76 may be a programmable logic controller (“PLC”). In one embodiment, the controller 76 is automated and capable of storing multiple control algorithms to perform time and/or pressure adjustments for each product application to control the desired level of infusion. The chamber 48 may alternately be controlled manually.

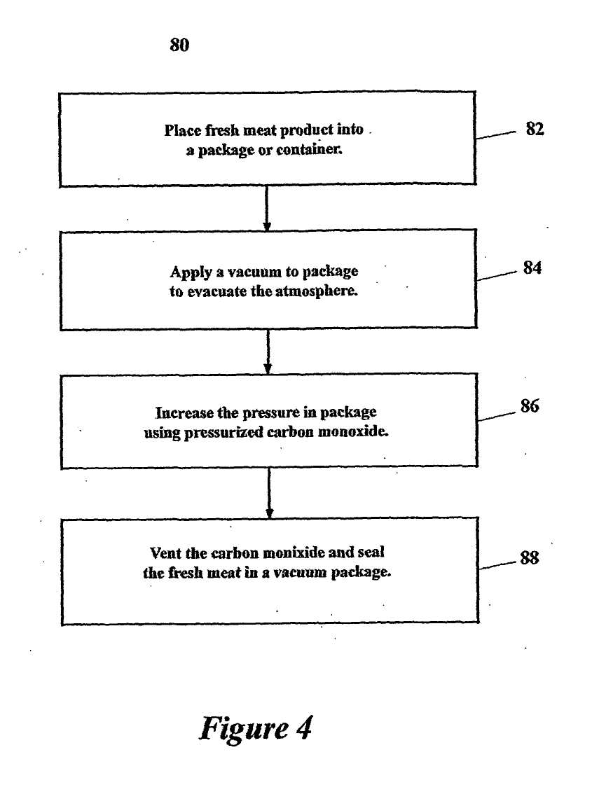

FIG. 4 is a flowchart showing a fresh meat packaging method 80, according to an alternative embodiment of the packaging system. The method 80 includes placing a fresh meat product into a package or container, shown at block 82, applying a vacuum to the package or container to evacuate the atmosphere, shown at block 84, increasing the pressure using pressurized carbon monoxide gas, shown at block 86, venting the carbon monoxide, and sealing the fresh meat product in a vacuum package, shown at block 88. The method 80 can be used with various types of packaging systems including overwrapped trays, form-fill-seal packages, and other types of vacuum packages. The fresh meat product may include, for example, fresh cuts of pork and beef.

It is to be noted that while the method shown in FIG. 4 includes placing a fresh meat product into a package or container, the invention is not limited to embodiments including a package. As discussed above, in relation to FIGS. 1-3, the meat may be placed directly into a pressure/vacuum chamber.

The vacuum applied to the fresh meat package, shown at block 84, may be from about 20 to about 29 inHg. For example, a vacuum pressure of 26 in Hg may be applied to the package. The vacuum pressure is applied for a sufficient time to remove substantially all of the atmosphere from the package. Example times for applying the vacuum are from about 1 to about 30 seconds, from about 5 to about 15 seconds, or for about 8 seconds.

The pressurized/hyperbaric carbon monoxide atmosphere is applied to the open package/exposed product at block 86. The carbon monoxide may be present along with an inert gas. The concentration of carbon monoxide may vary. Generally, a lower concentration of carbon monoxide requires a longer dwell time and/or higher pressure. Conversely, a higher concentration of carbon monoxide permits a more rapid dwell time and/or lower pressure. The package is pressurized with the carbon monoxide gas to a level sufficient to cause infusion of the fresh meat product's myoglobin with carbon monoxide. In one embodiment, the pressure in the package is from about 0.1 to about 5 bar. In another embodiment, a pressure of from about 0.5 to about 2 bar is applied to the package.

The transition or cycle time between a vacuum and an elevated pressure level may optionally be controlled.

Further, the vacuum step may be skipped according to a alternative embodiment. A vacuum enables carbon monoxide gas density to be reached at a lower pressure range and limits excessive introduction of other undesirable atmospheric gases such as oxygen.

The fresh meat package is then reevacuated and sealed, shown at block 88. In one embodiment, prior to sealing, the package is subjected to another cycle of vacuum and pressure. This cycling may continue until sufficient binding of the carbon monoxide to the fresh meat myoglobin has occurred. Sufficient binding may be determined by observing the visual appearance of the fresh meat product, which takes on a bright cherry-red color upon binding to the carbon monoxide. Prior to sealing, the package may be subjected to a second pressurized condition. The method 80 may include several cycles of pressurization followed by venting.

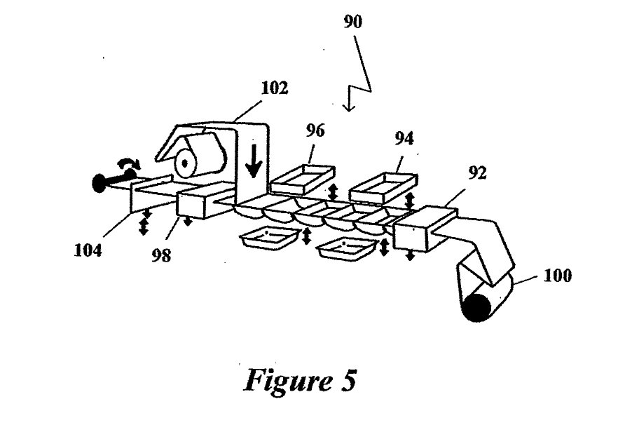

FIG. 5 is a schematic diagram showing a continuous, vacuum-packing system 90, according to another embodiment of the packaging system. As with FIG. 4, while the embodiment of FIG. 5 shows placing the meat in a package before CO infusion of the meat, the invention is not limited to embodiments including a package. As shown in FIG. 5, the system 90 includes a formation die 92, a vacuum chamber 94, a pressurized chamber 96 and a sealing die 98. A film 100 is drawn into the formation die 92 and a package is formed using any technique known in the art. In one embodiment, the film 100 is heated and a vacuum is used to draw the film into a mold having the desired configuration.

The system 90 then indexes the package to the next station, where the fresh meat product is added to the package. It then indexes to the vacuum chamber 94. The vacuum chamber 94 draws a vacuum on the package and the fresh meat product, as described above. The system then indexes to the pressurized chamber 96 where compressed carbon monoxide gas is used to subject the fresh meat product to a high pressure environment, as described above. At a venting station, the package may be vented to a location outside of the work area to ensure worker safety. The system 90 indexes the package and the fresh meat product to the next station, where the package is vacuum sealed using a second film 102. The system 90 indexes to a separation station 104, where the package is separated from the line and moved to storage or prepared for shipping. In one embodiment, the system 90 includes multiple vacuum chambers 94 or pressurized chambers 96 (or both) for subjecting the fresh meat product to multiple vacuum and high pressure cycles.

Color may be measured using three different values: hue angle, lightness and saturation. Hue angle is the actual “color” of the product (e.g., red or green). Lightness is a measure of the brightness of the color and saturation is a measure of the vividness. The hue of the product can be quantified by using numerical references relating to a* (redness) and b* (yellowness). Redness values that are positive indicate a red color and redness values that are negative indicate a green color. Yellowness values that are positive indicate a yellow color and yellowness values that are negative indicate a blue color. Lightness may be reported as L* on a 0 to 100 scale with 0 being black and 100 being absolute white. A colorimeter may be used to obtain results for the a*, b* and L* values. The hue angle and saturation can then be calculated using these values.

### EXAMPLE 1

Example 1 is in accordance with the embodiment of FIG. 2. Ground beef samples (N=70) were obtained from a commercial facility and divided into treatment groups of pressure and dwell time as depicted in Table 1. Each sample was placed in the pressure/vacuum chamber at block 30 of FIG. 2. The atmosphere was evacuated from the pressure/vacuum chamber as at block 32, thereby creating a negative atmospheric pressure within the pressure/vacuum chamber. As at block 34, the pressure/vacuum chamber was enriched with carbon monoxide gas in accordance to the treatment schedule of Table 1.

TABLE 1
4 × 6 Incomplete factorial treatment structure for number of ground
beef samples by dwell time^{a}, and pressure^{b} (N = 70).

| | |
|---|---|
| Pressure | Dwell time (min.) |

| (BAR) | 0.00 | 1.00 | 2.00 | 3.00 | Row Totals |
|---|---|---|---|---|---|
| CON | 5 | 0 | 0 | 0 | 5 |
| 0 | 5 | 0 | 0 | 0 | 5 |
| 2 | 0 | 5 | 5 | 5 | 15 |
| 4 | 0 | 5 | 5 | 5 | 15 |
| 6 | 0 | 5 | 5 | 5 | 15 |
| 8 | 0 | 5 | 5 | 5 | 15 |
| Column | 10 | 20 | 20 | 20 | 70 |
| Totals | | | | | |

^{a}Dwell time (min.): Time that ground beef samples were exposed to carbon-monoxide pretreatment, 0:00 = no treatment; 1:00 = 1 minute; 2:00 = 2 minutes and 3:00 = 3 minutes.
^{b}Pressure (BAR): Amount of pressure (inside the prototype apparatus) exerted by 100% carbon-monoxide gas on ground beef samples during pretreatment, measured in units of BAR over atmospheric pressure, CON = no treatment and not packaged under vacuum; 0 = no treatment and packaged under vacuum; 2 = 2 BAR; 4 = 4 BAR; 6 = 6 BAR and 8 = 8 BAR.

The meat, as at block 36, rapidly absorbed the carbon monoxide to varying values of lightness, redness, yellowness, hue and saturation, as seen in Tables 2 through 5. Once the designated carbon monoxide pressure and dwell time were reached, the pressurized carbon monoxide gas was removed from the pressure/vacuum chamber, as at block 38. Fresh air was allowed to flush through at normal atmospheric pressure. As at block 40, the pressure chamber was opened and the meat was removed. The myoglobin pigment of the meat within the pressure/vacuum chamber was rapidly converted to carboxymyoglobin and, thus, the meat appeared normally oxygenated.

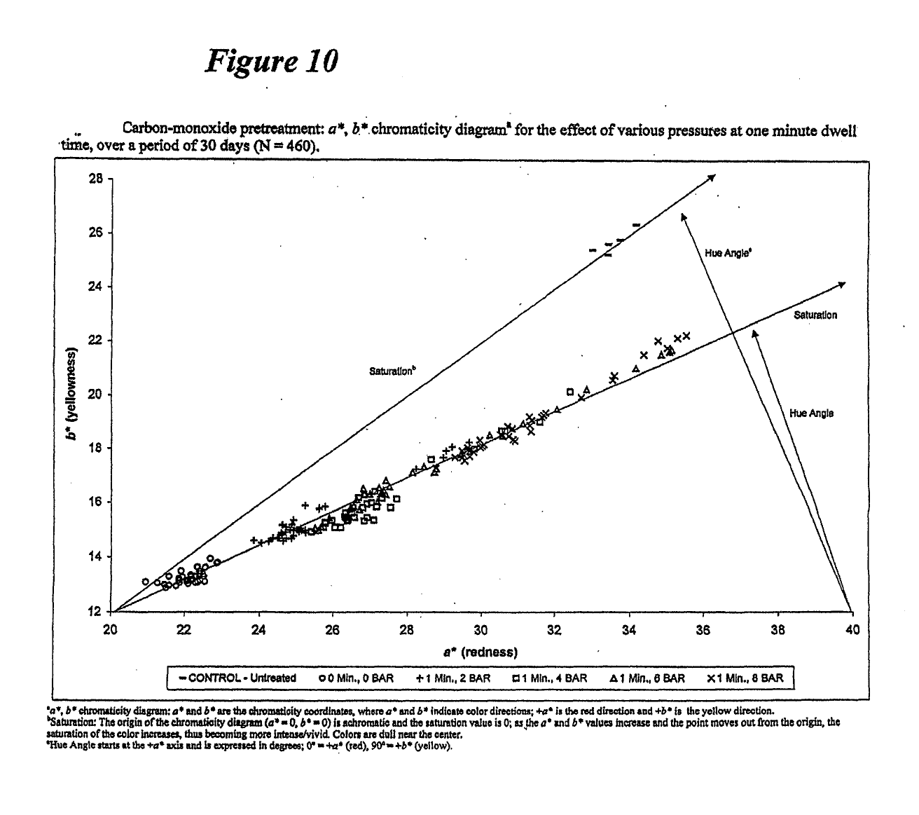

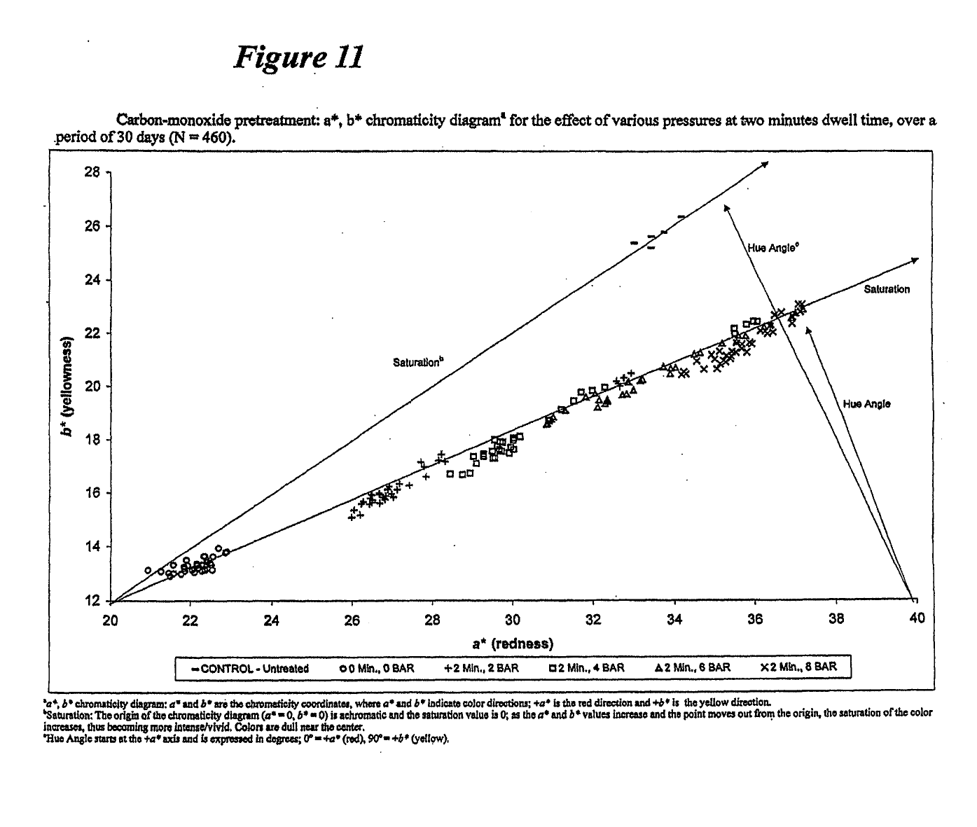

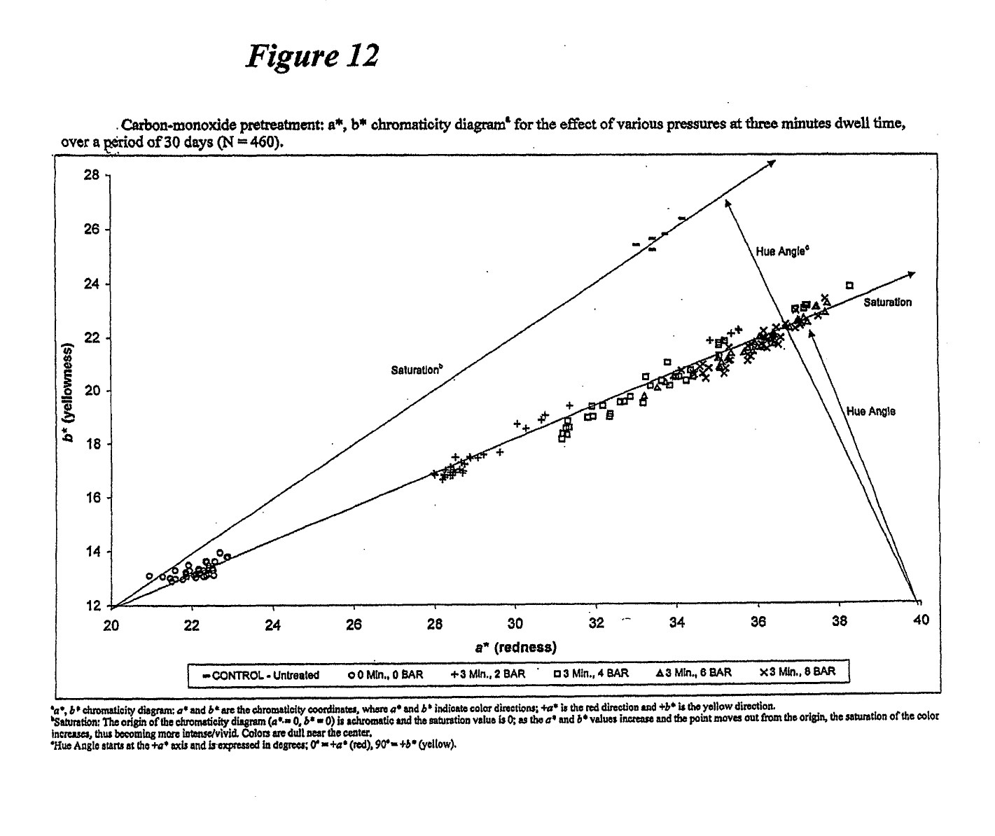

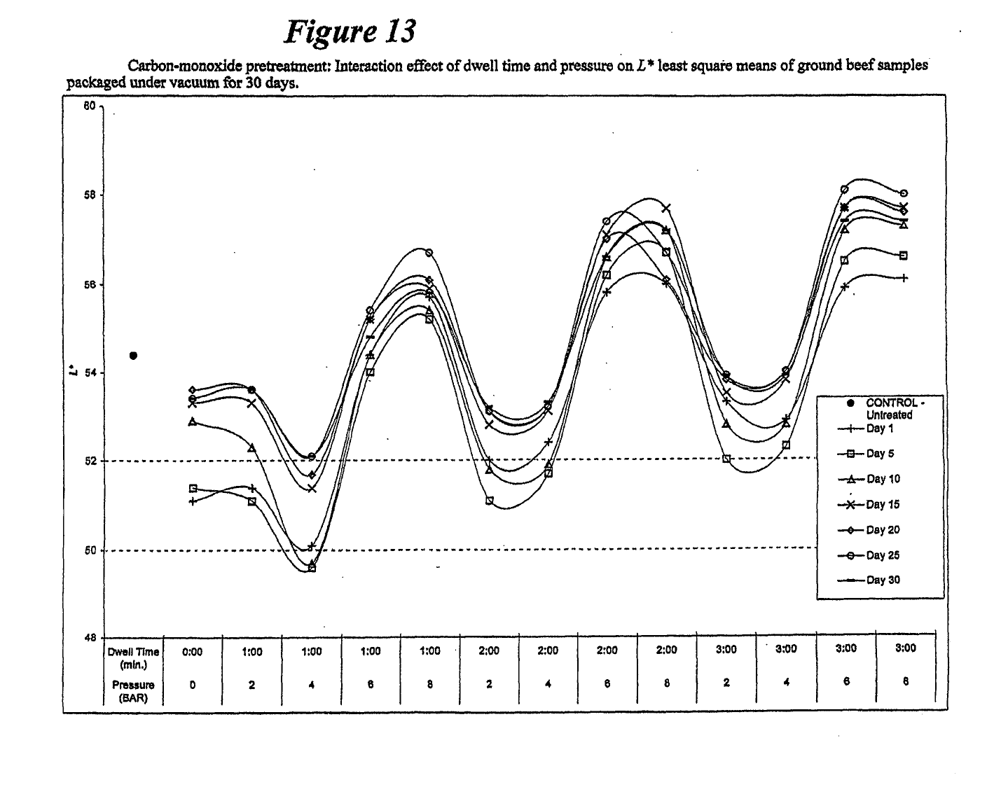

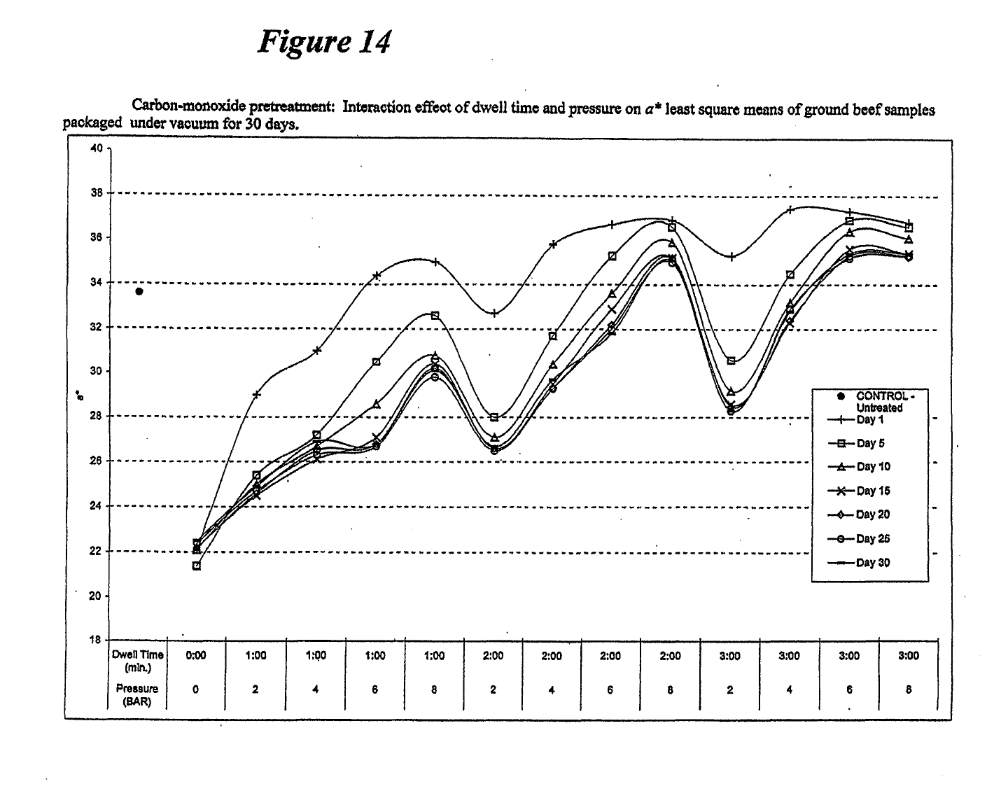

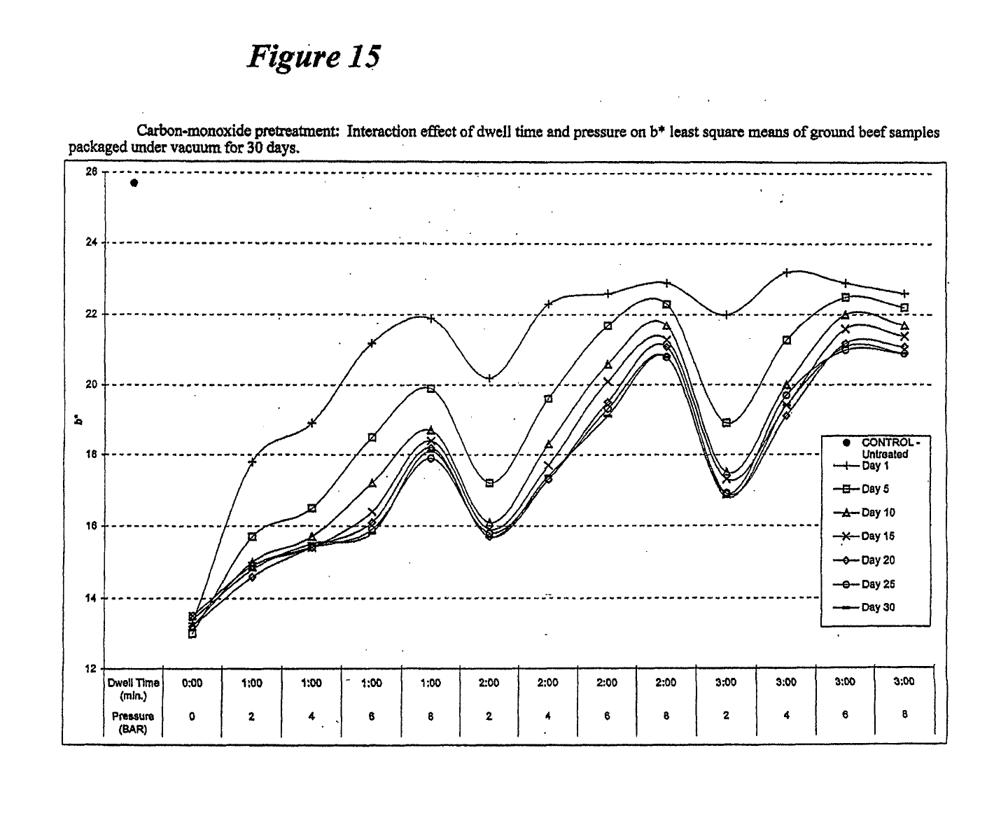

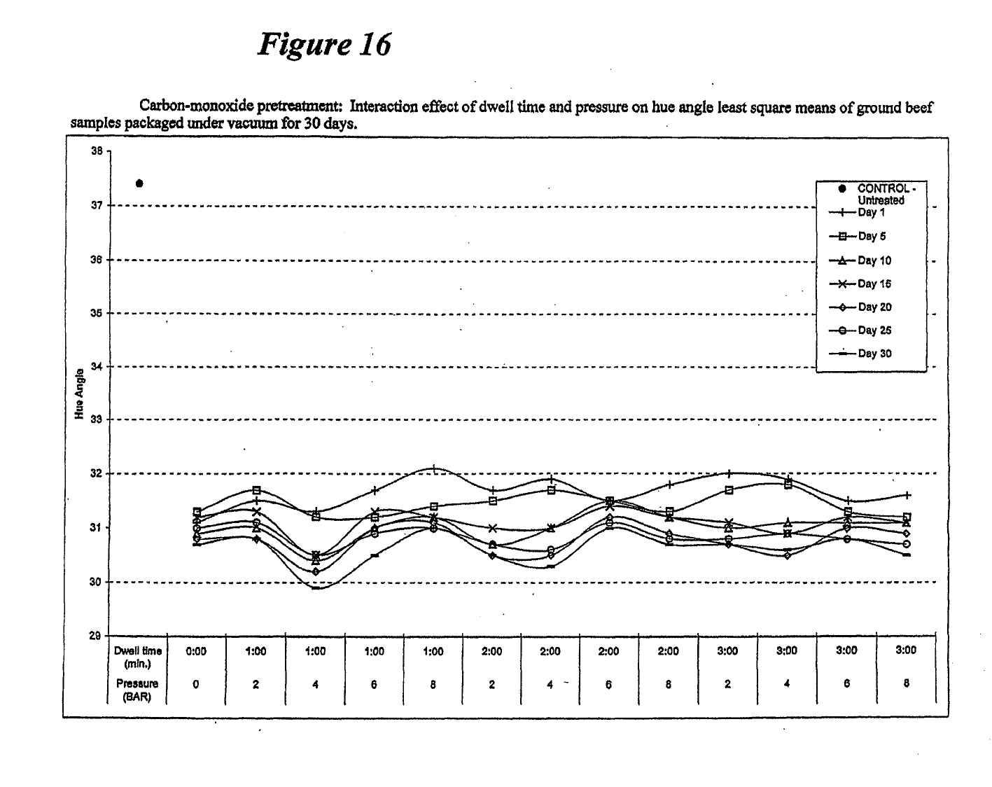

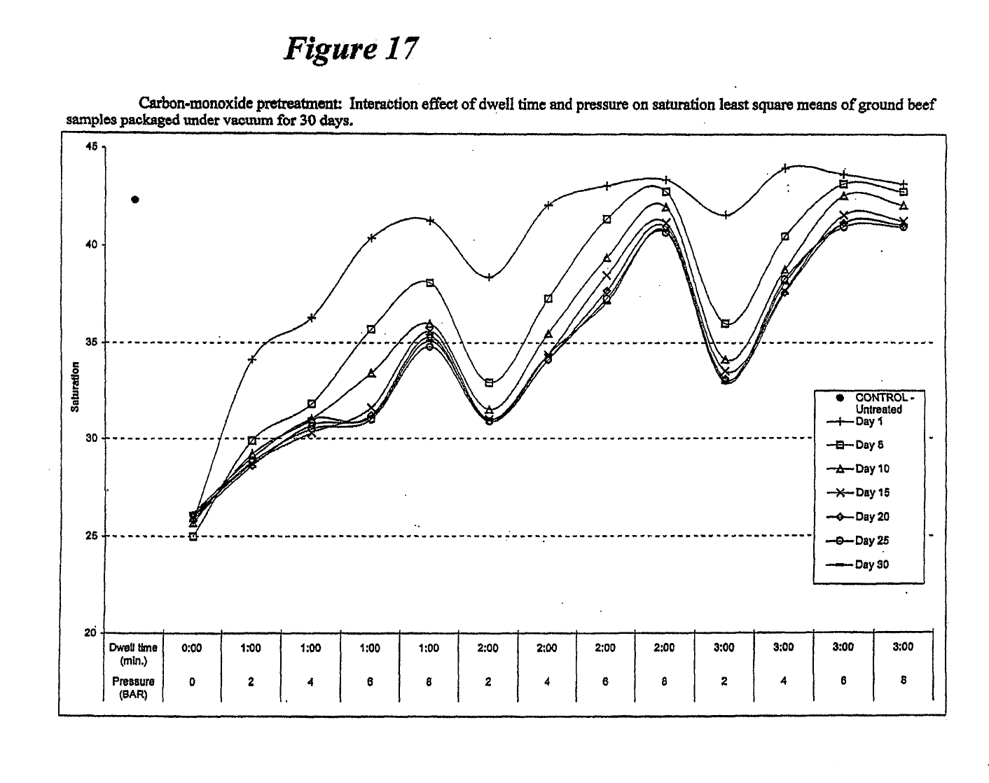

The meat was subsequently placed into a vacuum packaging machine and packaged in the absence of oxygen (vacuum package), as at block 42. Color values for each of the different treatments were obtained using a calorimeter during days 1, 5, 10, 15, 20, 25 and 30 post-packaging. It was observed that, with increased hyperbaric carbon monoxide pressure, the treated product depicted color values similar to that of naturally oxygenated product even though the carbon monoxide treated product was packaged in a vacuum package, which traditionally causes the naturally oxygenated product to change color from a naturally oxygenated bright cherry-red to a more purplish-red deoxymyoglobin color due to the absence of oxygen. Such rapid formation of carboxymyoglobin (very stable bright cherry-red state of the myoglobin pigment) and the subsequent increase in color values, in particular color saturation, was attributed to the application of elevated hyperbaric carbon monoxide atmosphere to the product, in addition to an interaction of carbon monoxide pressure with dwell time (FIGS. 10, 11 and 12). Within the pressure/vacuum chamber, the gas was pressurized and significantly dense, thus encouraging accelerated carbon monoxide uptake at the surface layer myoglobin of the fresh meat product. The impact of different carbon monoxide pressure levels and dwell times on the color values of the product is illustrated in FIGS. 13 through 17. FIG. 13 illustrates results for L* lightness. FIG. 14 illustrates results for a* redness. FIG. 15 illustrates results for b* yellowness. FIG. 16 illustrates results for hue angle. FIG. 17 illustrates results for saturation.

With respect to the above description, it is to be realized that the optimum dimensional relationships for the parts of the invention include variations in size, materials, shape, form, function and manner of operation, assembly and use. All equivalent relationships to those illustrated in the drawings and described in the specification are intended to be encompassed by the packaging system.

Although the packaging system has been described with reference to preferred embodiments, persons skilled in the art will recognize that changes may be made in form and detail without departing from the spirit and scope of the invention.

We claim:

1. An apparatus for rapid binding of gas to fresh meat myoglobin, the apparatus comprising:
a support for supporting a fresh meat product;
a pressure vessel for forming a seal with the support wherein the fresh meat product may be positioned within the pressure vessel;
a compressed carbon monoxide source coupled to the pressure vessel for pressurizing the pressure vessel with a positive pressure of between approximately 10 atm and approximately 34 atm using an atmosphere; and
a vacuum source coupled to the pressure vessel for drawing a vacuum in the pressure vessel;
wherein the fresh meat treated using the apparatus is rapidly imparted with a cherry-red color.

2. The apparatus of claim 1, wherein the carbon monoxide source provides a gas mixture comprising at least about 10 percent carbon monoxide.

3. The apparatus of claim 1, wherein the carbon monoxide source provides a gas mixture comprising a percentage of carbon monoxide less than 100%.

4. The apparatus of claim 3, wherein the gas mixture further comprises nitrogen.

5. The apparatus of claim 1, further comprising an air cylinder coupled to the pressure vessel for causing motion of the pressure vessel with respect to the support.

6. The apparatus of claim 1, wherein the compressed carbon monoxide source is coupled to the pressure vessel using a dual-position valve.

7. The apparatus of claim 1, further comprising an exhaust for venting the pressure vessel.

8. The apparatus of claim 1, further comprising a controller for controlling the air cylinder, the compressed carbon monoxide source, and the vacuum source.

9. The apparatus of claim 1, wherein the vacuum source is adapted to draw a vacuum within the pressure vessel of from about 0.7 to about 1.0 atm.

10. The apparatus of claim 1, wherein the fresh meat product is a fresh beef cut.

11. A method for rapidly changing the state of meat myoglobin comprising:
placing meat in chamber,
creating a negative pressure within the chamber;
pressurizing the chamber with a positive pressure of between approximately 10 atm and approximately 34 atm with an atmosphere including carbon monoxide;
maintaining the chamber at hyperbaric levels of pressure for a dwell time;
bringing the chamber to regular atmospheric pressure.

12. The method of claim 11, wherein the atmosphere comprises at least about 10 percent carbon monoxide.

13. The method of claim 11, wherein the dwell time is sufficient to convert the meat myoglobin to carboxymyoglobin.

14. The method of claim 11, wherein the dwell time is no more than approximately 2 minutes.

15. The method of claim 11, wherein pressurizing the chamber with an atmosphere including carbon monoxide comprises pressurizing the chamber with an atmosphere including a mixture of gases including carbon monoxide, wherein the mixture of gases comprises at least about 10 percent carbon monoxide.

16. The method of claim 11, further comprising creating a negative pressure within the chamber prior to bringing the chamber to regular atmospheric pressure.

17. The method of claim 11, further comprising packaging the meat.

18. The method of claim 17, wherein packaging the meat comprises vacuum packaging the meat.

19. The method of claim 11, further comprising maintaining the chamber at a negative pressure for a dwell time prior to pressurizing the chamber with an atmosphere including carbon monoxide.

20. The method of claim 11, wherein pressurizing the chamber with an atmosphere including carbon monoxide is done to approximately 34 atm.

21. The method of claim 11, further comprising, after maintaining the chamber at hyperbaric levels of pressure, creating a negative pressure within the chamber a second time, pressurizing the chamber with an atmosphere including carbon monoxide, and again maintaining the chamber at hyperbaric levels of pressure for a time period sufficient to completely convert the meat myoglobin to carboxymyoglobin.

22. An apparatus for rapid binding of gas to fresh meat myoglobin, the apparatus comprising:
a chamber housing a fresh meat product, wherein the chamber comprises means for creating a seal around the fresh meat product;
means for pressurizing the chamber coupled to the chamber for pressurizing the chamber with a positive pressure of between approximately 10 atm and approximately 34 atm; and
means for creating a negative pressure within the chamber coupled to the chamber;
such that fresh meat treated using the apparatus is rapidly imparted with a cherry-red color.

23. The apparatus of claim 22, wherein the means for pressurizing the chamber provides a gas mixture comprising at least about 10 percent carbon monoxide.

24. A vacuum packaged meat product comprising:
fresh meat, the fresh meat having a generally red coloration carboxymoglobin on a surface thereof, the fresh meat thus having a cherry-red color;
a vacuum package around the fresh meat.
